(19) United States
(12) Patent Application Publication
(10) Pub. No.: US 2009/0059553 A1
(43) Pub. Date: Mar. 5, 2009

(54) LIGHT GUIDING STRUCTURE AND MANUFACTURING OF THE SAME

(76) Inventor: Tai-Yen Lin, Kaohsiung (TW)

Correspondence Address: Jenny Chen, 7F, No. 1, Alley 30, Lane 358,, Rueiguang Road, Neihu District, Taipei, 114, TW

(21) Appl. No.: 12/116,247

(22) Filed: May 7, 2008

Related U.S. Application Data
(60) Provisional application No. 60/927,962, filed on May 8, 2007.

(51) Int. Cl. G01D 11/28; C03B 37/022

(52) U.S. Cl. 362/26; 65/386

(57) ABSTRACT

The present invention discloses a light guiding system, applied to a portable device configured with at least a keying unit; an illuminator producing incident light to illuminate said portable device. The light guiding system comprising: a light guiding structure; at least an incident portion provided on a side of the light guiding structure to receive the incident light from the illuminator; a plurality of light guiding portions to guide the incident light to the at least one keying unit; and a chemical layer provided on the light guiding structure.

### CROSS-REFERENCE TO RELATED APPLICATIONS

This application is related to and claims priority to U.S. provisional patent application, U.S. Provisional Application No. 60/927,962, filed on May 8, 2007, by the applicant Tai-Yen Lin, entitled “Light Guiding Structure And Manufacturing Of The Same.”

### FIELD OF THE INVENTION

The present invention relates to a light guiding system; more particularly, the present invention relates to a light guiding system applied to a portable or handheld device equipped with at least a keying unit and at least an illuminator.

### BACKGROUND OF THE INVENTION

Nowadays, portable or handheld electronic devices from the video conferencing sector, information sector, communication sector, home appliance sector, and consumer section; such as mp3 players, cell phone, personal digital assistant (PDA), and remote controller, have become an indispensable part of our daily life, but sometimes the need to use the devices in occasions without sufficient lighting has always been a nuisance. To allow the portable or handheld electronic devices to be used under insufficient lighting, or to improve the design of these devices, adding light source into the handheld electronic devices has become a major development trend so far.

Generally, Light Emitting Diode (LED) is often used as the light source in the portable or handheld electronic devices, and a light-guiding plate is applied to guide the light generated by LED. In addition, because the light source from LED is in the form of a point source, it is critical to allow the pointed light source from LED to be evenly spread onto the whole surface, so that the illumination can be distributed evenly. This issue is the major challenge facing the current technology, and has been addressed in other patent disclosures, for instance, in U.S. Pat. No. 5,083,240.

In U.S. Pat. No. 5,083,240, a plurality of V-shaped light guiding troughs are located at each side of the light-guiding structure in a light-guiding plate, and a plurality of LED light sources are located underneath the bottom surface of the light-guiding structure. In addition, convex lens are placed on the bottom surface of the light-guiding structure where it is opposite to a plurality of LED light sources, so that the light from the light sources can be reflected. However, because of the need to use multiple LED for the light-guiding plate in this patent, the cost is comparatively more expensive, and the LED consumes a large amount of electricity as well. Moreover, the addition of convex lens requires relatively more processing procedures during the production, which brings the production cost higher as a result. On the other hand, by arranging the light source underneath the light-guiding plate, the overall thickness of the resulted device is increased as well, and hence impeding the miniaturization of the device.

Additionally, because U.S. Pat. No. 5,083,240 has to form groove-like reflectors around the perimeter of the light guide plate and to cut corners for reflecting some of the light, such light guiding plate is hard to fabricate. It can only be fitted to one specific model, but can hardly be applied to other devices, thereby complicating the fabrication process, increasing cost of production, and narrowing down its scope of industrial applications and utilization. Moreover, as the light is emitted directly from the underneath light source, the type of lighting method employed by U.S. Pat. No. 5,083,240 is a type of directed-lighting, which is also a major cause of Hot Spot effect and over-lighting. With the arrangement of U.S. Pat. No. 5,083,240, the light would be focused on the central areas of the light guiding plate of U.S. Pat. No. 5,083,240, causing over-illumination and Hot Spot effect. Light could barely get to the peripheral area of the light guiding plate.

In the prior arts, problems like the failure of light emission, uneven illumination, complicated structure, difficulty in production, higher cost, and difficulty in application by the industry still exist. As a result, it is urgent for the industry to come up with a simple structure that can be manufactured easily as well as improve the light-guiding plate, so that the illumination can be spread evenly. Ideally, such solution can also lower cost and elevate industrial applications. Finding solutions to deal with the problems arising from the prior arts has become the most critical issues for the industry. Solutions to these problems have been long sought but prior developments have not taught or suggested any solutions, and thus solutions to these problems have long eluded those skilled in the art.

### SUMMARY OF THE INVENTION

In light of the drawbacks of the above prior arts, the primary object of the present invention is to provide a light guiding system for improving illumination of a portable device with a keying unit.

Another object of the present invention is to provide a light guiding system in order to give a more relatively even light distribution to the portable device.

Still another object of the present invention is to provide a light guiding system that can reduce the use of light source and lower energy consumption.

A further object of the present invention is to provide a light guiding system that has a simply structure and can be fabricated in an easy manner so that the cost of production can be reduced.

Yet another object of the present invention is to provide an inexpensive light guiding system with high industrial values that can be applied to a wide variety of applications.

In accordance with the foregoing and other objects, the present invention is to provide a light guiding system that can be applied to any device, and mainly to any portable or handheld device such as a remote controller, a keyboard, a mouse, a headset, a cellular phone, a desktop phone, a wireless phone, a game controller, a game pad, a portable video device, a portable audio device, a calculator, a personal digital assistance device (PDA), a locking device, an alarm system, and a security system, which is formed with at least a keying unit and ate least an illuminator, such that light generated by the illuminator can be transmitted to the keying unit via the light guiding system for illuminating the keying unit of the device. The light guiding system comprises a light guiding structure, at least a coupling portion coupling with a corresponding keying unit of the portable device, at least an incident portion receiving incident light generated by illuminator, and at least a light guiding portion for directing and relatively evenly distributing light to the coupling portion.

The light guiding structure of the light guiding system may be a flat plate, a flare-shaped plate, a wedge-shaped plate, a plate with a compressed end at one end thereof, a plate with a wedged end at one end thereof, and a plate with a wedged end at each end thereof. The light guiding structure may be made of a material selected from a group consisting of gum, rubber, glass, plastic, (poly)silicone, (poly)silane, polycarbonate (PC), polymethyl (meth)acrylate (PMMA), Polystyrene (PS), Polyamide (PA), methyl(meth)acrylate-styrene (MS), Polybutylene terephthalate (PBT), Polyethylene terephthalate (PET), Polypropylene (PP), Polyvinyl chloride (PVC), Acrylonitrile-Butadiene-Styrene resin (ABS), Polyethylene (PE), and a mixture thereof such that the light guiding structure may be light-transmittable. Furthermore, the light guiding structure may be treated by a physical process, such as polishing, cutting, physical vapor deposition, physical sputtering, or faceting, or by a chemical process, such as coating, sputtering or chemical vapor deposition process, such that the treated light guiding structure of the light guiding system can improve refraction and/or reflection of light, or achieve total internal reflection of light. However, it should be noted that any physical process or chemical process, which can allow the treated light guiding structure to produce such effects, may be applied.

Furthermore, the incident portion of the light guiding system may further be formed with a prism. Moreover, the incident portion may be in any of the following shapes: flat, curved, trianged, regular-triangled, and reverse-triangled, polygon-shaped, convex-shaped, concave-shaped, wave shaped-V-shaped, W-shaped, reverse V-shaped, reverse W-shaped, and trapezoid-shaped. However, the shapes and sizes of the incident portion may vary and should not be limited to what have been described and illustrated here. In one preferred embodiment, the incident portion may be an opening throughout the light guiding structure. In another preferred embodiment, the incident portion may be a recession located at the bottom surface or at one of the sides of the light-guiding structure. In yet another preferred embodiment, the incident portion may be arranged at a side of the coupling portion.

Moreover, the light guiding system may further be associated with at least a cover member, wherein the cover member may be made of a material selected from a group consisting of gum, rubber, glass, plastic, (poly)silicone, (poly)silane, polycarbonate (PC), polymethyl methacrylate (PMMA), Polystyrene (PS), Polyamide (PA), methylmethacrylate-styrene (MS), Polybutylene terephthalate (PBT), Polyethylene terephthalate (PET), Polypropylene (PP), Polyvinyl chloride (PVC), Acrylonitrile-Butadiene-Styrene resin (ABS), Polyethylene (PE), and a mixture thereof. Preferably, the cover member is made of materials with a high reflection of light or capable of absorbing light depending on the materials selected and/or the mixing ratio thereof. The cover member may further comprise adhesive materials on at least a surface thereof. The cover member may also be either a single-sided tape or a double-sided tape. In one preferred embodiment, at least a side of the incident portions may be covered by the cover member. Alternatively, when an illuminator is provided on one side the light guiding structure in a tilted manner, the cover member may be adhesively provided on the illuminator so as to cover the incident light. In another preferred embodiment, the light guiding structure of the light guiding system may further comprise at least a stepped structure, wherein the stepped structure is coupled with the cover member. Moreover, the stepped structure may have at least two steps located at an edge of the light guiding structure of the light guiding system, wherein the difference between the height of the top surface of an upper step and the height of the top surface of a lower step is about the thickness of the cover member.

Moreover, at least a coupling portion may be a cavity, and at least a light guiding portion may be a polygonal opening. The size of the coupling portion is properly configured for receiving the corresponding keying unit of the portable device. In one preferred embodiment, the light-guiding portion of different forms may also be made into the light-guiding structure as required. For instance, a light guiding portion may be triangular shaped, rectangular shape, circular shape or polygonal shaped. In other words, the light guiding structure of the light guiding system may have different shapes of light guiding portions, such that at least two light guiding portions are formed in two different shapes. Preferably, a surface of a sidewall in the light-guiding portion may be at least one of the forms mentioned in the group consisting of a flat surface, a curved surface, a concave-shaped surface, a convex-shaped surface, a spike-shaped surface, a wave-shaped surface, a lattice-shaped surface, and a free-form surface, wherein at least a light guiding portion may have at least two sidewalls with different forms. In one embodiment, a portion of the sidewall of the light guiding portion may be a concave surface for diverging the incident light, and the other portion of the sidewall may be a convex surface for converging the incident light. In yet another embodiment, at least a sidewall of at least a light guiding portion may be further applied with at least two different refractive index materials or reflective materials. For example, a portion of a sidewall of the light guiding portion may be coated with a high refractive index material or a reflective material, and the other portion of the sidewall may be coated with a low refractive index material.

Alternatively, the present invention may provide a light guiding system without the aforementioned coupling portions; instead, a layer of diffusing ink is printed on the light guiding structure corresponding to the keying units. In one preferred embodiment, the layer of diffusing ink is patterned with a plurality of holes in various shapes so as to destroy the complete reflection of the light guiding structure, thereby guiding the incident light to the keying unit. Additionally, the holes closer to the illuminator where the incident light is brighter are smaller than those farther away from the illuminator so as to result in uniform distribution of light. In another embodiment, the light guiding structure without any coupling portion may be provided with an illuminator at a location other than the bottom of the light guiding system. Specifically, the illuminator may be installed at a location within the light guiding structure such that incident light produced cannot reach certain keying units by printing diffusing ink on the light guiding structure alone. However, in this embodiment, the incident portions may be utilized together with the diffusing ink so as to transmit partial incident light to those keying units.

In the present invention, a light-guiding system with the design of a plurality of polygonal light-guiding portions for the refraction/total reflection of light is provided. Therefore, by taking advantages of the characteristics of the light-guiding portion, the light directly generated by LED can be evenly directed and distributed onto each of the coupling portions. As a result, the light can be focused onto each coupling portion and provides sufficient light-splitting/light-gathering effects, thereby eliminating the disadvantages of the prior arts like uneven lighting and lost light, and in turn fulfilling the aim of acquiring even illumination. In addition, the application of the present invention can achieve even illumination by the use of simplified structures instead of the complicated structures in the prior arts; as a result, problems from the previous arts such as difficulty in production, higher cost, and difficult industrial application can be overcome. In other words, the present invention is not burdened by difficulty in production like the prior arts was, hence it can lower cost of production and widen its scope of industrial applications as a result.

Therefore, the light-guiding system of the present invention cannot only achieve an even illumination, it is also structurally simple and easy to produce, has lower production cost and can be used in a wide variety of industrial applications. In other words, the light-guiding system of the present invention has addressed the problems arising from the prior arts.

In accordance with the present invention, a method of manufacturing the light guiding structure is also provided. The method of manufacturing the light guiding structure includes an extrusion process to melt raw materials into a continuous form with a controlled thickness as well as a stamping process to use a mold with a protrusion to stamp the continuous melted raw materials into the light guiding structure. In a preferred embodiment, the extrusion process further comprises the following steps: pouring raw materials into a feed; heating a plurality of screws in a heater so as to melt the raw materials into the continuous form; passing the continuous melted raw materials through a die, preferably a T-Die, so as to form the continuous melted raw materials into a predetermined shape; passing the continuously predetermined-shaped melted raw materials through two rollers with a controlled gap so as to form the controlled thickness; releasing internal thermal stress of the continuously predetermined-shaped melted raw materials by cooling the continuously predetermined-shaped melted raw materials on a cooling table; and measuring the thickness of the continuously predetermined-shaped melted raw materials by a thickness gauge. In this preferred embodiment, the controlled thickness is between 0.05 mm and 0.3 mm. Preferably, the raw materials is selected from a group consisting of gum, rubber, glass, plastics, (poly)silicone, (poly)saline, polycarbonate (PC), polymethyl (meth)acrylate (PPMA), polystyrene (PS), polyamide (PA), methyl(meth)acrylate-styrene (MS), polybutylene terephthalate (PBT), polyethylene terephthalate (PET), polypropylene (PP), polyvinyl chloride (PVC), acrylonitrile-butadiene-styrene resin (ABS), polyethylene (PE), phenol-formaldehyde resin (PF), and a mixture thereof.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF DRAWINGS

FIG. 1 is a schematic structural view of a light-guiding system in accordance with a first preferred embodiment of the present invention;

FIGS. 2A to 2C are schematic structural views of a light-guiding portion in accordance with a first preferred embodiment of the present invention;

FIG. 3 is a schematic structural view of a light-guiding system in accordance with a second preferred embodiment of the present invention;

FIGS. 4A to 4B are cross-sectional views of the structure described in FIG. 3, wherein FIG. 4A is a cross-sectional view showing the AA section in FIG. 3 under dissection, and FIG. 4B is a schematic view showing a partially enlarged FIG. 4A;

FIG. 5A to 5F are schematic structural views of a light-guiding system in accordance with a third preferred embodiment of the present invention;

FIGS. 6A to 6H are schematic enlarged views illustrating a portion of each of modified incident portions in light-guiding system in accordance with the preferred embodiments of the present invention;

FIGS. 7A to 7E are side views showing a light-guiding structure of the light-guiding system in accordance with the preferred embodiments of the present invention;

FIGS. 8A and 8B are schematic views depicting a light guiding system in accordance with a fourth preferred embodiment of the present invention; and

FIG. 9 shows a flow chart of a method of manufacturing the light guiding structure in accordance with the present invention.

### DETAILED DESCRIPTION OF THE INVENTION

The following embodiments are described in sufficient detail to enable those skilled in the art to make and use the invention. It is to be understood that other embodiments would be evident based on the present disclosure, and that proves or mechanical changes may be made without departing from the scope of the present invention.

In the following description, numerous specific details are given to provide a thorough understanding of the invention. However, it will be apparent that the invention may be practiced without these details. In order to avoid obscuring the present invention, some well-known configurations and process steps are not disclosed in detail.

Likewise, the drawings showing embodiments of the structure are semi-diagrammatic and not to scale and, particularly, some of the dimensions are for the clarity of presentation and are shown greatly exaggerated in the drawing figures. Similarly, although the views in the drawings for ease of description generally show similar orientations, this depiction in the figures. is arbitrary for the most part. Generally, the invention can be operated in any orientation.

For expository purposes, the term “horizontal” as used herein is defined as a plane parallel to the plane or surface of the substrate, regardless of its orientation. The term “vertical” refers to a direction perpendicular to the horizontal as just defined. Terms, such as “on”, “above”, “below”, “bottom”, “top”, “side” (as in “sidewall”), “higher”, “lower”, “upper”, “over”, and “under”, are defined with respect to the horizontal plane.

The following embodiments have employed a portable device that has a plurality of keying units and at least a light source capable of illuminating the device and the keying units for expository purposes only, thus the present invention should not be limited to that described and illustrated.

### FIRST EMBODIMENT

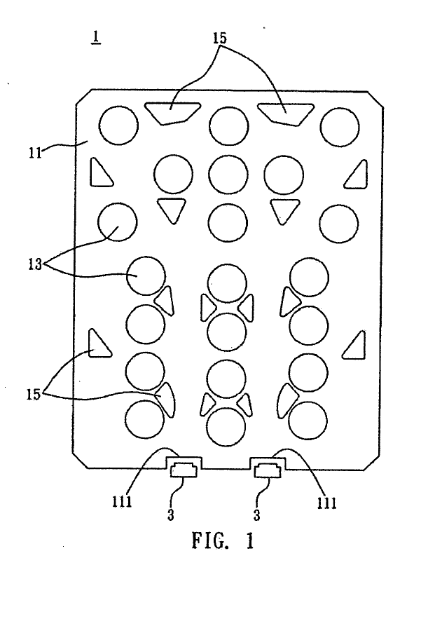

In a first embodiment, as shown in FIG. 1, the light guiding system 1 may be installed in a portable device having a plurality of keying units (not shown) and a plurality of illuminators 3, such that incident light produced by the illuminators 3 can be transmitted and distributed to each keying unit by the use of the light guiding system 1. Furthermore, the keying units may be exposed from a side of a casing of the portable device. In this embodiment, the light guiding system 1 comprises a light guiding structure 11; a plurality of coupling portions 13 on the light guiding structure for coupling with corresponding keying units; at least an incident portion 111 for receiving incident light produced by the illuminator 3; and a plurality of light guiding portions 15 for guiding the incident light to each coupling portion 13.

The light guiding structure 11 of the light guiding system 1 may have a top surface, a bottom surface and lateral surfaces. Furthermore, the lateral surfaces and the bottom surface of the light guiding structure 11 may be treated with at least one of a physical process and a chemical process, such that the lateral surfaces and the bottom surface of the light guiding structure 11 may selectively have a relatively lower refraction of light and a relatively higher reflection of light. Specifically, the physical process may include a cutting process, a physical vapor deposition process, a physical sputtering process, a faceting process or a polishing process, whereas the chemical process may include a chemical vapor deposition process, a sputtering process or a coating process.

Additionally, the light guiding structure 11 may be made of a material selected from a group consisting of gum, rubber, glass, plastics, (poly)silicone, (poly)silane, polycarbonate (PC), polymethyl (meth)acrylate (PPMA), polystyrene (PS), polyamide (PA), methyl(meth)acrylate-styrene (MS), polybutylene terephthalate (PBT), polyethylene terephthalate (PET), polypropylene (PP), polyvinyl chloride (PVC), acrylonitrile-butadiene-styrene resin (ABS), polyethylene (PE), phenol-formaldehyde resin (PF), and a mixture thereof. Preferably, the light guiding structure 11 is made of a material that has a high light transmittance, such as plastics, glass materials, and any mixture of the above materials. In this embodiment, the light guiding structure 11 is rectangular-shaped, wherein the thickness of the light guiding structure 11 is larger than or equal to that of each illuminator 3, but is not limited thereto. The light guiding structure 11 can be formed into any shape, including but not limited to flat, flare, wedge, one compressed end, two compressed ends, one wedged end, and two wedged ends, as long as the keying units of the portable device can fit with the light guiding structure 11.

Furthermore, at least one incident portions 111 may be formed on one side of the light guiding structure 11 at locations corresponding to a respective illuminator 3 so as to receive incident light produced therefrom. Alternatively, the at least one incident portion may be formed at the bottom of the light guiding structure 11 or at an edge of the light guiding structure 11. As shown in FIG. 1, the incident portions 111 are rectangular-shaped recessions corresponding to two illuminators 3, such as light emitting diodes (LED).

The light guiding system 1 of the present invention may be optionally equipped with a single illuminator 3 at a corresponding incident portion to reduce energy consumption, or equipped with two or more illuminators at corresponding portions to increase intensity of light, if required. Furthermore, the illuminator 3 may be any light source capable of producing light other than light emitting diode. The location and the amount of the illuminators may vary and should not be limited to that described and illustrated herein. Since light emitting diode is well known in the art and not a technical feature of the present invention, it is therefore not to be further described hereinafter.

In accordance with the present invention, each of the coupling portions 13 may be an opening. In this preferred embodiment, the coupling portions 13 are round holes, or openings formed according to the shape of the keying unit of the portable device. In other words, the shape and the sizes of each of the coupling portions 13 are formed in a manner allowing the keying units (not shown) to fit with the corresponding coupling portions 13. Thus, the shape and the sizes of the coupling portions 13 may be varied according to the arrangement and the design of the keying units (not shown) of different portable device.

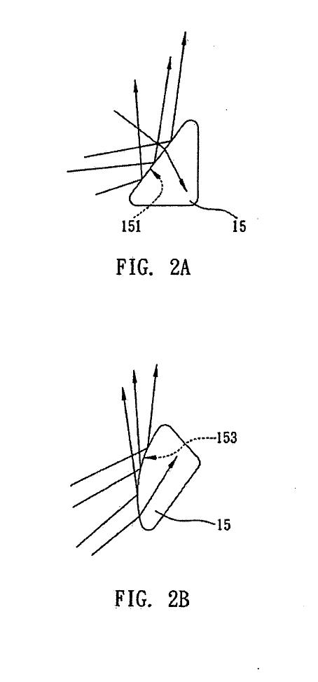

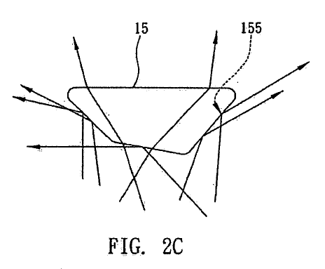

In accordance with the present invention, a plurality of light guiding portions may be capable of refracting or reflecting the incident light so as to transmit and disperse the incident light to at least one of the coupling portions 13. The light guiding portions 15 of the present invention may be polygonal openings. Preferably, at least two light guiding portions 15 may be formed with different shapes on the light guiding structure 11. Moreover, the light guiding portions 15 may comprise a first subgroup and a second subgroup, the first subgroup of the light guiding portions 15 distributed at the perimeter of the light guiding structure 11, while the second subgroup of the light guiding portions 15 distributed at central areas of the light guiding structure 11, such that the light guiding system 1 can intensify the illumination effect and increase rightness of the peripheral areas of the device. In the embodiment, as shown in FIG. 1 in conjunction with FIGS. 2A to 2C, the first subgroup of the light guiding portions 15 is triangular-shaped and the second subgroup is rectangular-shaped.

Furthermore, each of the light guiding portions 15 may have a sidewall with at least one of the following surfaces, namely a flat surface, a curved surface, or a free-form surface. As a result, even if the light rays are parallel and coming from the same direction, the incident rays may meet different kinds of shapes or surfaces (a flat surface or a curved surface) of each of the light guiding portions 15 at different locations, thereby entering the light guiding portions 15 at different incident angles. Consequently, the light rays may travel in various directions and exit the light guiding portions 15 at different emergent angles such that the light rays may be scattered in various locations, and widely distributed in the light guiding system 1.

In other words, when the light produced by the illuminator 3 enters the light guiding structure 11 through the incident portion 111, as shown in FIGS. 2A to 2C, the incident light striking at a sidewall of the light guiding portion 15 comprising at least one of a flat surface 151, a curved surface 153, or a freeform surface 155 may be partially or completely refracted and/or reflected (traveling paths of light are shown as arrows in the drawings), such that the light is widely scattered to every coupling portion 13 and keying units (not shown) to provide an extensive illumination for the portable device.

Moreover, some surfaces of the light guiding portions 15 may be wave-shaped with some rough ground portions, and thus the light rays may be reflected at different reflection angles, resulting in diffuse reflection of light. Accordingly, the light can be transmitted to more areas such that the light guiding system 1 can provide a more extensive and intense illumination into the portable device. However, it should be noted that in another embodiment, the light guiding portion 15 may be any structure capable of refracting or reflecting light based upon theories of refraction, reflection or total internal reflection (TIR). Therefore, the form of the light guiding portions 15 should not be limited to that illustrated or described herein.

Since the shape of the light guiding portions 15 may be modified based upon the principle of optics by those skilled in the art, it is therefore not to be further described hereinafter. In addition to the arrangement of this embodiment where each of the coupling portions 13 is separated apart from each of the light guiding portions 15, each or some of the coupling portions 13 may also be connected or coupled with each or some of the light guiding portions 15 in another embodiment.

Comparing to the prior art, the design of a plurality of light-guiding portions 15 in the light-guiding system 1 of the present invention allows the light to be focused and distributed onto the areas requiring illumination, such that the present invention can provide sufficient lighting throughout the portable device by the use of simplified structures under lower production cost.

### SECOND EMBODIMENT

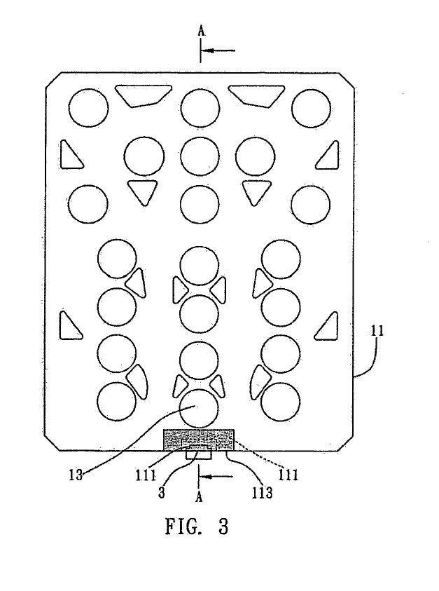

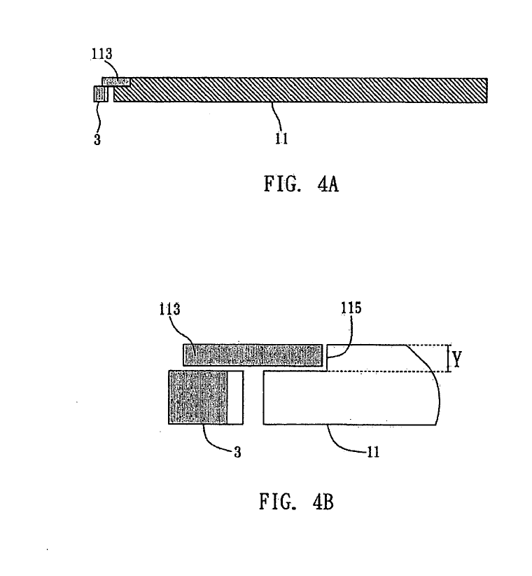

FIG. 3 and FIGS. 4A to 4B are schematic views depicting the light guiding system 1 in accordance with a second preferred embodiment of the present invention. Most of the structure of the light guiding system 1 of the second preferred embodiment is similar to that of the first preferred embodiment; however, the light guiding system 1 of the second preferred embodiment further comprises a cover member 113.

In this embodiment, the cover member 113 is placed on the light guiding structure 11 at a location above a side of the incident portion 111 corresponding to the illuminator 3. Furthermore, the cover member 113 may be made of a material selected from the group consisting of gum, rubber, glass, plastics, (poly)silicone, (poly)silane, polycarbonate (PC), polymethyl (meth)acrylate (PPMA), polystyrene (PS), polyamide (PA), methyl(meth)acrylate-styrene (MS), polybutylene terephthalate (PBT), polyethylene terephthalate (PET), polypropylene (PP), polyvinyl chloride (PVC), acrylonitrile-butadiene-styrene resin (ABS), polyethylene (PE), phenol-formaldehyde resin (PF), and a mixture thereof. Preferably, the cover member 113 is made of materials with a low refractive index, a high reflection rate or capable of absorbing light depending on the materials selected or a mixing ratio thereof. The cover member 113 may further comprise adhesive materials on at least a surface thereof so as to adhere to the light guiding structure 11. Alternatively, the cover member 113 may also be either a single sided tape or a double sided tape.

Moreover, in another embodiment, the light guiding structure 11 of the light guiding system 1 may further comprise at least a stepped structure 115, wherein the difference between the height of the top surface of an upper step and the height of the top surface or a lower step is greater than or equal to the thickness Y of the cover member 113, such that the top surface of the cover member 113 is coplanar with the top surface of the light guiding structure 11 without forming difference in height between the top surface of the cover member 113 and the top surface of the light guiding structure 11.

The cover member of this embodiment configured at a location near the illuminator 3 can reflect or absorb the light emitting or escaping from the light source, preventing over-illumination of the coupling portions 13. This thereby avoids Hot Spot Effect and achieves a more even light distribution, providing a brighter illumination for portable device.

Although the cover member 113 is rectangular-shaped in this embodiment, it is not limited thereto. The cover member 113 may be formed into any shape upon demand. For example, the cover member 113 may be circular-shaped, oval-shaped, saw-shaped or polygonal-shaped as well. Moreover, it should be understood that the quantity, the thickness, the location and the material of the cover member may be varied or modified according to practical implementations.

### THIRD EMBODIMENT

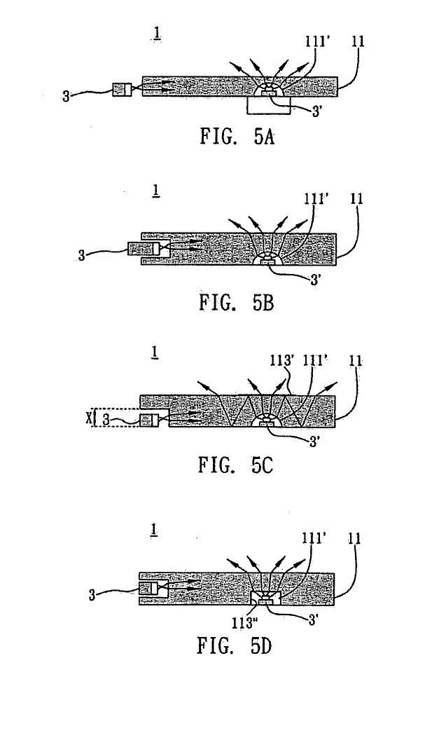

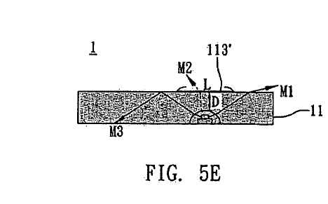

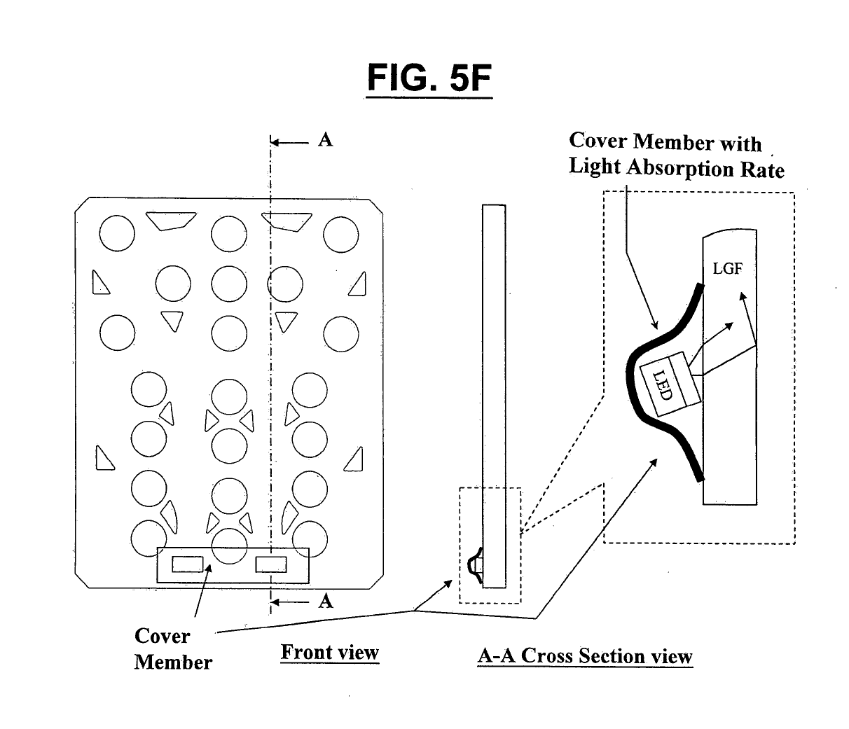

FIGS. 5A to 5F are schematic views depicting a light guiding system 1 in accordance with a third preferred embodiment of the present invention. Most of the structure of the light guiding system 1 of the third preferred embodiment is similar to that of the first preferred embodiment; however, the light guiding system 1 of the third preferred embodiment may be equipped with direct lighting (referring to the illuminator 3′ as shown in FIGS. 5A to 5D), equipped with direct and side lighting, or equipped with tilted lighting.

Referring to FIG. 5A, an incident portion 111′ of the light guiding system 1 is formed on the bottom surface of the light guiding structure 11 at a location corresponding to an illuminator 3′ such as an LED. Arrangement as such may be applied to a particular area required a high intensity of illumination. Furthermore, if the light guiding system 1 is equipped with the direct lighting as well as the side lighting (referring to the illuminator 3 as shown in FIG. 1), the direct lighting (illuminator 3′) can supplement illumination of areas with insufficient lighting.

Referring to FIGS. 5A to 5D, the side lighting (illuminator 3) may be placed coplanar with the light guiding structure 11, partially or completely embedded in the light guiding structure 11, or covered by the stepped structure of the light guiding structure 11.

As shown in FIG. 5C, a cover member 113′ is mounted on the light guiding structure 11 at a location corresponding to the side lighting illuminator 3′, wherein the bottom surface of the light guiding structure 11 may be further treated with a physical process or a chemical process, so as to prevent the reflected light escaping from the light guiding structure 11. Furthermore, as shown in FIG. 5D, a cover member 113″ may be attached to a side of the incident portion 111′.

In addition, as shown in FIG. 5E, arrow M1 represents the light escaping from the light guiding structure 11, arrow M2 represents the light blocked and reflected by the light guiding structure 11, and arrow M3 represents total internal reflection of the light. The cover member 113′ may be ideally fabricated as long as possible, in order to reflect most of the light and prevent light escaping from the light guiding structure 11. However, since any angle of incidence greater than the critical angle, which is the angle of incidence according to Snell's law at which a refracted light travels along the interface between two media such as the air and the light guiding structure 11, the light would undergo total internal reflection (as shown by M3), and the design of fabricating oversize of cover member would be unnecessary and could increase the cost of production. Thus, in order to avoid unnecessary interference by the cover member 113′, and lower the cost of production, the length of the cover member 113′ may be defined by the following formula:

$$L \geq \frac{2 D}{\sqrt{{n}^{2} - 1}}$$

Where L is the length of the cover member, D is the distance between the incident portion of the incident light emitted from the illuminator 3′ to the top surface of the light guiding structure 11, and n is the value of refractive index of the light guiding structure 11.

In yet another configuration, as shown in FIG. 5F, the illuminators 3 are shown in a tilted manner on one side of the light guiding structure 11. Accordingly, the cover member may be an adhesive, or be adhesively provided on the illuminators 3 so as to minimize Hot Spot effect. Preferably, the cover member is made of materials with a high reflection of light or capable of absorbing light depending on the materials selected and/or the mixing ratio thereof. In addition, with the illuminator 3 provided on one side of the light guiding structure 11 and secured thereon by means of adhesive, the light guiding structure 11 may be free of the incident portion 111 (111′), thereby thinning and/or minimizing the light guiding structure 11 so as to simplify the fabrication processes and to reduce the fabrication time and costs.

Moreover, if a liquid crystal display, a field emission display, a plasma display panel, an electro-luminescence display or any illumination device is employed to be the illuminator 3 instead of a light emitting diode, a side of the light guiding structure 11 coplanar with or adjacent to the illuminator 3 is then treated by means of physical process or chemical processes so as to transmit the emitting light into the light guiding structure 11.

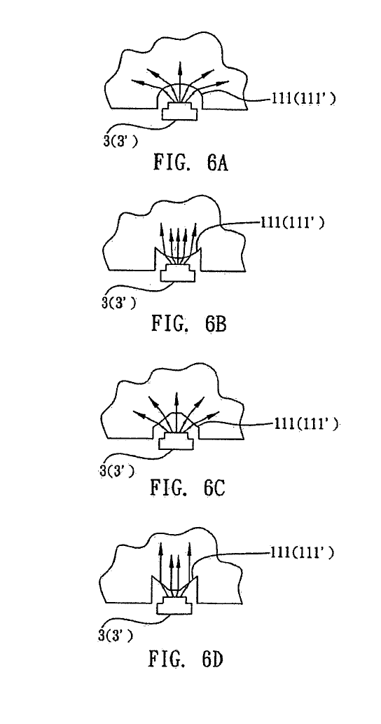

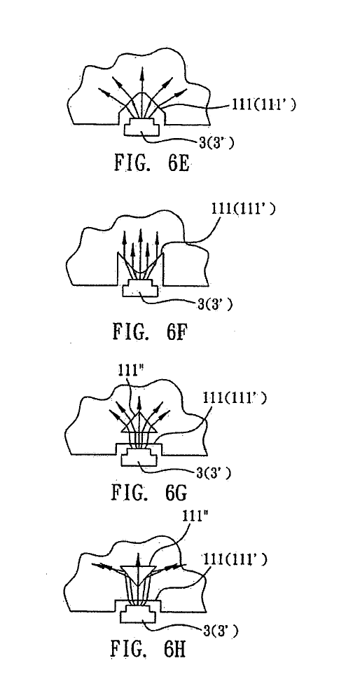

Furthermore, the size and shape of the incident portion 111 (111′) may be modified as shown in FIGS. 6A to 6H, but is not limited to that described or illustrated herein. For instance, the incident portion 111 (111′) may be rectangular, curved-shaped, concave-shaped (as shown in FIG. 6A) or convex-shaped (as shown in FIG. 6B), wherein the concave-shaped incident portion is capable of diverging light and the convex-shaped incident portion is capable of converging light. Moreover, a surface of the curved-shaped incident portion is capable of smoothing the effect of divergence or convergence, because the curved-shaped incident portion is featured in having a lot of gradient values.

Apart from that, the incident portion 111 (111′) may be trapezoid-shaped (as shown in FIG. 6C) or reverse trapezoid-shaped (as shown in FIG. 6D). The incident portion 111 (111′) formed into trapezoid or reverse trapezoid, provides an effect that is similar to that of the curved-shaped incident portion. However, as a side (hypotenuse) of trapezoid has a constant gradient, thus the divergence or convergence of light is fairly uni-directional.

In addition, as shown in FIGS. 6G to 6H, the incident portion 111 (111′) may further comprise another incident portion 111″ on the light guiding structure 11, wherein the incident portion 111″ may be a prism or a triangular opening. Comparing to the V-shaped incident portion, after the incident light generated by the illuminator 3 (3′) passed through the first incident portion 111 (111′), the incident light is further refracted or reflected by the triangular incident portion 111″, allowing the light to travel in more different directions, so as to generate more light paths and achieving a better light distribution. It should be understood that the incident portion of the present invention may be of a shape from the group consisting of flat, curved, triangled, regular-triangled, and reverse-triangled, polygon-shaped, convex-shaped, concave-shaped, wave-shaped, V-shaped, W-shaped, reverse V-shaped, reverse W-shaped, and trapezoid-shaped. However, the quantity, shape and size of the incident portion may vary and should not be limited to what have been described and illustrated here.

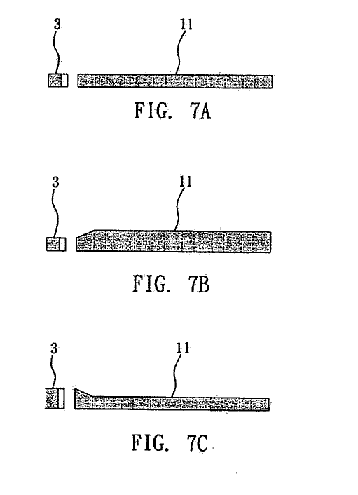

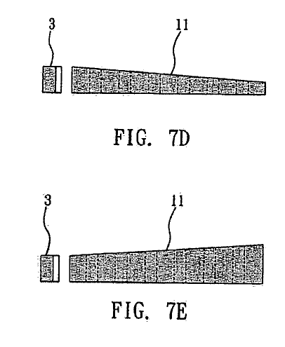

In the foregoing embodiments, the thickness of the light guiding structure 11 is preferably larger than or equal to that of the illuminator 3, but is not limited thereto. The light guiding structure may be modified as shown in FIGS. 7A to 7E.

Referring to FIG. 7A, the light guiding structure 11 is formed as a plate, wherein the thickness of the light guiding structure 11 is equal to that of the illuminator 3. Furthermore, referring to FIG. 7B, the light guiding structure 11 is a plate having a compressed end corresponding to the illuminator 3, wherein the thickness of the compressed end is equal to that of the illuminator 3, and the thickness of the other portion of the light guiding structure 11 is larger than that of the illuminator 3. Referring to FIG. 7C, the light guiding structure 11 has a flare-shape end, wherein the thickness of the flare-shape end is larger than or equal to that of the illuminator 3, wherein the thickness of other portions of the light guiding structure 11 is smaller than or equal to that of the illuminator 3. Referring to FIG. 7D, the light guiding structure 11 is a wedge-shape plate, wherein an end near the illuminator 3 is equal to or larger than that of the illuminator, and the thickness of the other portions of the light guiding structure 11 is gradually reduced. Additionally, referring to FIG. 7E, the light guiding structure 11 is also a wedge-shape plate, wherein an end of the illuminator 3 is equal to that of the illuminator, and the thickness of the other portions of the light guiding structure 11 is gradually increased.

As aforementioned, it should be understood that the light guiding structure 11 of the light guiding system 1 may be a flat plate, a flare-shaped plate, a wedge-shaped plate, a plate with a compressed end at one end thereof, a plate with a compressed end at each end thereof, a plate with a wedged end at one end thereof, and a plate with a wedged end at each end thereof. Furthermore, the light guiding structure 11 may be treated by a physical process such as polishing, cutting, physical vapor deposition, physical sputtering, or faceting, or by a chemical process such as coating, sputtering or chemical vapor deposition process, such that the treated light guiding structure 11 of the light guiding system 1 may improve refraction and/or reflection of light, or achieve total internal reflection of light. However, it should be noted that any physical process or chemical process, which can allow the treated light guiding structure 11 to produce such effects, may be applied.

### FOURTH EMBODIMENT

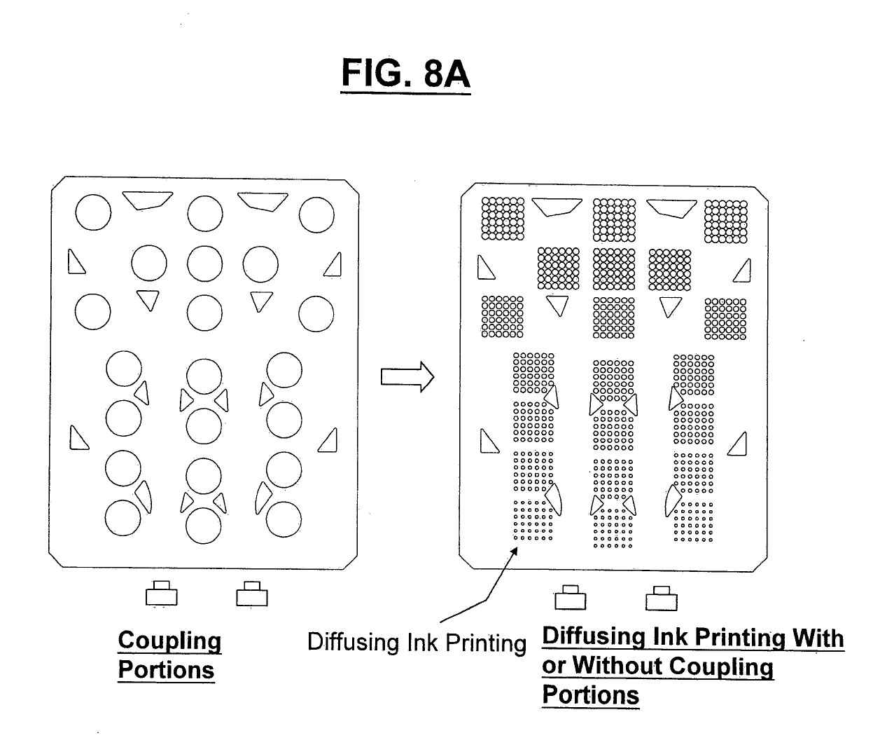

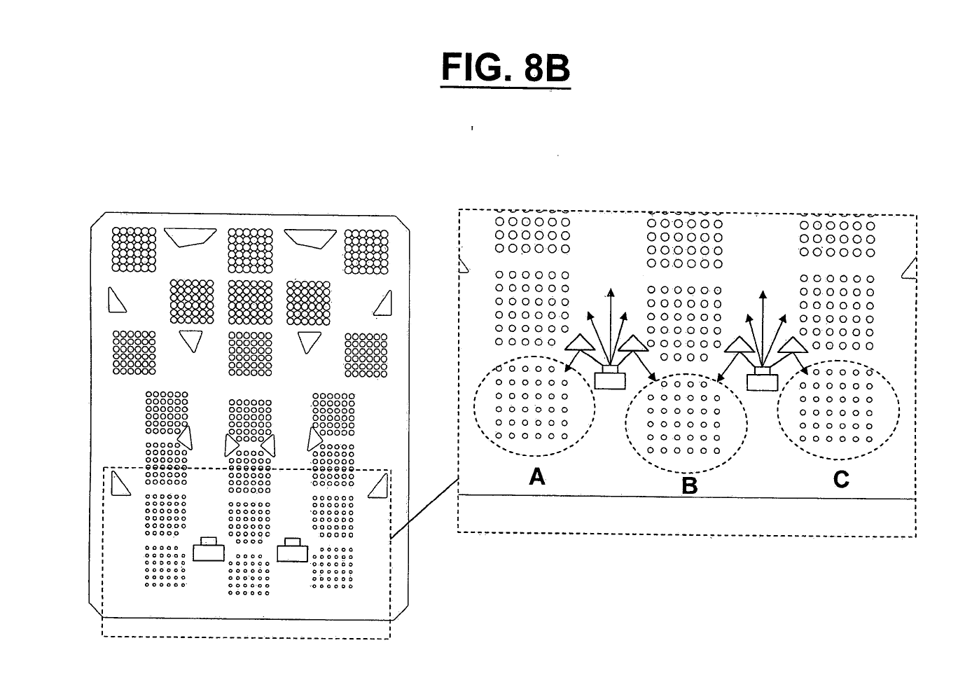

FIGS. 8A and 8B are schematic views depicting a light guiding system 1 in accordance with a fourth preferred embodiment of the present invention. Most of the structure of the light guiding system 1 of the fourth preferred embodiment is similar to that of the first preferred embodiment; however, the light guiding system 1 of the fourth preferred embodiment does not have any coupling portions 13. Additionally, the illuminators 3 are provided at different locations so as to further illustrate the advantages of the present invention.

Refer to FIG. 8A. The light guiding structure 11 is shown without any coupling portion; moreover, the illuminators 3 are located at the bottom of the light guiding structure 11. In this embodiment, a layer of diffusing ink may be printed on the light guiding structure 11 corresponding to the keying units of the portable device. Because the light guiding structure 11 may be made sufficiently thin, even if no coupling portions 13 are provided on the light guiding structure 11, the sensitivity of the keying units will not be affected. In this preferred embodiment, the layer of diffusing ink is patterned with a plurality of holes in various shapes so as to destroy the complete reflection of the light guiding structure 11, thereby guiding the incident light to the keying units. For example, the plurality of holes may be in circular, square, diamond or hive shape. Preferably, the holes closer to the illuminator 3 where the incident light is brighter are smaller than those farther away from the illuminator 3 so as to result in uniform distribution of light.

Refer to FIG. 8B. The light guiding structure 11 is shown without any coupling portion as shown in FIG. 8A; however, the illuminators 3 are installed within the light guiding structure 11. Due to a confined space in the portable device, sometimes it is inevitable to design the illuminators 3 at a location less than ideal, as shown in FIG. 8B. At this point, utilizing the technique of diffusing ink printing alone cannot solve the problem that the incident light cannot reach places such as A, B, and C. However, when combining the features of diffusing ink printing and the incident portions 111, the diffusing ink may first destroy the complete reflection of the incident light, and then the incident portions 111 may transmit partial of the incident light to the places such as A, B and C, and thus achieving uniform distribution of light. In other words, the incident portions 111 effectively utilize the incident light produced by the illuminators 3 while the layer of diffusing ink uniformly distributes the incident light in accordance with the present invention.

### FIFTH EMBODIMENT

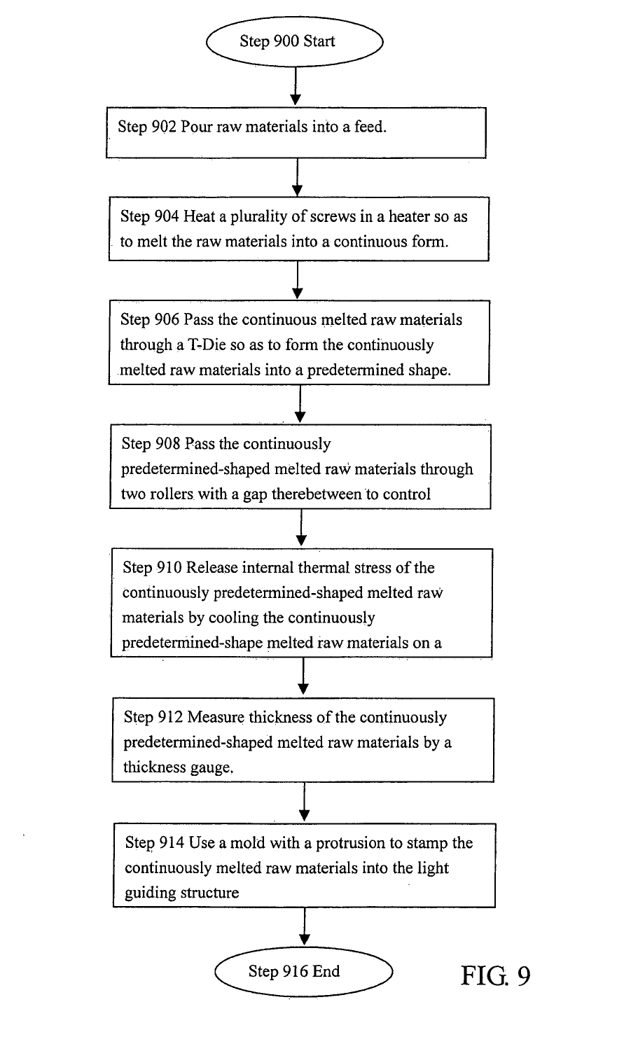

FIG. 9 shows a flow chart of a method of manufacturing the light guiding structure 11 in accordance with the present invention. The method of manufacturing the light guiding structure includes an extrusion process to melt raw materials into a continuous form with a controlled thickness as well as a stamping process to use a mold with a protrusion to stamp the continuously melted raw materials into the light guiding structure. In accordance with the present invention, the light guiding structure is manufactured with shorter cycle and better quality. As shown in FIG. 9, the method starts at step 900. At step 902, raw materials are poured into a feed. Then, at step 904, a plurality of screws in a heater is heated so as to melt the raw materials into a continuous form. The continuously melted raw materials are then passed through a die, preferably a T-Die, so as to form the continuously melted raw materials into a predetermined shape such as a tubular or a sheet shape or any free form according to demand at step 906. In order to form a controlled thickness, the continuously shaped melted raw materials are passed through two rollers with a gap therebetween at step 908. In other words, the gap is used to define the thickness of the continuously shaped melted raw materials. Then at step 910, internal thermal stress of the continuously predetermined-shaped melted raw materials is released by cooling the continuously shaped melted raw materials on a cooling table. At the end of the extrusion process, the thickness of the continuously shaped melted raw materials is measured by a thickness gauge at step 912. Then, at step 914, the stamping process includes using a mold with a protrusion to stamp the continuously melted raw materials into the light guiding structure 11. Finally, the method ends at step 916. In this preferred embodiment, the controlled thickness is between 0.05 mm and 0.3 mm. As a result, the light guiding structure is flexible. Alternatively, the aforementioned method may further comprise an imprinting process so as to form at least one light guiding portion on said light guiding film; and at least a physical process or a chemical process so as to form a layer on said light guiding film. In one preferred embodiment, said physical process and said chemical process may be polishing, cutting, faceting, molding, deposition, sputtering, coating, diffusion or any process that may form a layer on the light guiding structure. For instance, said chemical process may be an ink diffusion and said chemical layer may be a diffusing ink layer. Said diffusion ink layer may comprise with a plurality of holes or protruding portions. Preferably, the raw materials is selected from a group consisting of gum, rubber, glass, plastics, (poly)silicone, (poly)silane, polycarbonate (PC), polymethyl (meth)acrylate (PPMA), polystyrene (PS), polyamide (PA), methyl(meth)acrylate-styrene (MS), polybutylene terephthalate (PBT), polyethylene terephthalate (PET), polypropylene (PP), polyvinyl chloride (PVC), acrylonitrile-butadiene-styrene resin (ABS), polyethylene (PE), phenol-formaldehyde resin (PF), and a mixture thereof.

Accordingly, the present invention is capable of transmitting and directing the incident light to a larger number of locations of a portable or handheld device, as well as providing a more even illumination by the use of the light guiding portions. Thus, problems from the previous arts such as difficulty in production, higher cost, and difficult industrial application can be overcome. In other words, the present invention can not only solve the problems of the prior arts, but also lower cost of production and widen its scope of industrial applications, and utilization.

While the invention has been described in conjunction with exemplary preferred embodiments, it is to be understood that many alternatives, modifications, and variations will be apparent to those skilled in the art in light of the foregoing description. Accordingly, it is intended to embrace all such alternatives, modifications, and variations that fall within the scope of the included claims. The scope of the claims, therefore, should be accorded the broadest interpretation so as to encompass all such modifications and similar arrangements. All matters set forth herein or shown in the accompanying drawings are to be interpreted in an illustrative and non-limiting sense.

What is claimed is:

1. A method of manufacturing a light guiding film, said method comprising:
an extrusion process, melting raw materials into a continuous form with a controlled thickness; and
a stamping process, using a mold with a protrusion to stamp continuously melted raw materials into said light guiding film,
wherein said extrusion process further comprises the following steps:
pouring said raw materials into a feed;
heating a plurality of screws in a heater so as to melt said raw materials into said continuous form;
passing said continuously melted raw materials through a die so as to form said continuously melted raw materials into a predetermined shape;
passing said continuously melted raw materials in said predetermined shape through two rollers with a controlled gap so as to form said controlled thickness;
releasing an internal thermal stress of said continuously melted raw materials in said predetermined shape by cooling said continuously melted raw materials in said predetermined shape on a cooling table; and
measuring said thickness of said continuously melted raw materials in said predetermined shape by a thickness gauge.

2. The method of manufacturing a light guiding film of claim 1, wherein said thickness is between 0.05 mm and 0.3 mm.

3. The method of manufacturing a light guiding film of claim 1, wherein said raw materials is selected from a group consisting of gum, rubber, glass, plastics, (poly)silicone, (poly)silane, polycarbonate (PC), polymethyl (meth)acrylate (PPMA), polystyrene (PS), polyamide (PA), methyl(meth)acrylate-styrene (MS), polybutylene terephthalate (PBT), polyethylene terephthalate (PET), polypropylene (PP), polyvinyl chloride (PVC), acrylonitrile-butadiene-styrene resin (ABS), polyethylene (PE), phenol-formaldehyde resin (PF), and a mixture thereof.

4. The method of manufacturing a light guiding film of claim 1, wherein said light guiding structure is flexible.

5. A light guiding system, applied to a portable device configured with at least a keying unit; an illuminator producing incident light to illuminate said portable device, said light guiding system comprising:
a light guiding structure;
at least an incident portion provided on a side of said light guiding structure to receive said incident light from said illuminator;
a plurality of light guiding portions to guide said incident light to said at least one keying unit; and
a chemical layer provided on said light guiding structure.

6. The light guiding system of claim 5, wherein said chemical layer is a diffusing ink layer.

7. The light guiding system of claim 5, wherein said chemical layer forms a plurality of protruding portions or a plurality of holes.

8. The light guiding system of claim 5, wherein said light guiding structure having a bottom surface and lateral surfaces, said bottom surface and lateral surfaces treated with at least one of a physical process or a chemical process such that said bottom surface and said lateral surfaces selectively having a relatively lower refraction of light and a relatively higher reflection of light

9. The light guiding system of claim 5, wherein a sidewall of at least one of said plurality of light guiding portions comprises a surface selected from the group consisting of a flat surface, a curved surface, a concave-shaped surface, a convex-shaped surface, a spike-shaped surface, a wave-shaped surface, a rectangular-shaped surface, a lattice-shaped surface, and a free-form surface.

10. The light guiding system of claim 5, wherein said illuminator is placed in a tilted manner on said light guiding structure, or placed coplanar with said light guiding structure partially or completely embedded in said light guiding structure.

11. The light guiding system of claim 5, further comprising at least a cover member provided on said light guiding structure at a location corresponding to said at least one incident portion for reflecting said incident light, wherein said cover member is made of a relatively lower refractive index material, a relatively higher reflective index material or a light absorbing material.

12. The light guiding system of claim 11, wherein said cover member further comprises an adhesive on at least a side thereof.

13. The light guiding system of claim 11, wherein said cover member is made of a material selected from a group consisting of gum, rubber, glass, plastics, (poly)silicone, (poly)silane, polycarbonate (PC), polymethyl (meth)acrylate (PPMA), polystyrene (PS), polyamide (PA), methyl(meth)acrylate-styrene (MS), polybutylene terephthalate (PBT), polyethylene terephthalate (PET), polypropylene (PP), polyvinyl chloride (PVC), acrylonitrile-butadiene-styrene resin (ABS), polyethylene (PE), phenol-formaldehyde resin (PF), and a mixture thereof.

14. The light guiding system of claim 7, wherein said plurality of holes or said plurality of protruding portions are in circular, square, diamond or hive shape.

15. The light guiding system of claim 7, wherein a portion of said plurality of holes or protruding portions closer to said illuminator is smaller than another portion of said plurality of holes or protruding portions farther away from said illuminator.

16. The light guiding system of claim 5, wherein said plurality of light guiding portions comprises a first subgroup and a second subgroup, said first subgroup is distributed at a perimeter of said light guiding structure, said second subgroup is distributed at central areas of said light guiding structure, said first subgroup and second subgroups are in different shapes.

17. The light guiding system of claim 5, wherein said light guiding structure is a plate with one of the following shapes: flat, flare, wedge, one compressed end, two compressed ends, one wedged end, and two wedged ends.

18. The light guiding system of claim 5, wherein said plurality of light guiding portions is made of a material selected from a group consisting of gum, rubber, glass, plastics, (poly)silicone, (poly)silane, polycarbonate (PC), polymethyl (meth)acrylate (PPMA), polystyrene (PS), polyamide (PA), methyl(meth)acrylate-styrene (MS), polybutylene terephthalate (PBT), polyethylene terephthalate (PET), polypropylene (PP), polyvinyl chloride (PVC), acrylonitrile-butadiene-styrene resin (ABS), polyethylene (PE), phenol-formaldehyde resin (PF), and a mixture thereof.

19. The light guiding system of claim 5, wherein said light guiding structure further comprises at least one stepped structure having at least an upper step and at least a lower step at an edge of said light guiding structure, wherein a difference X in height between a top surface of said upper step and a top surface of said lower step is equal to or greater than a thickness of said illuminator.

20. The light guiding system of claim 5, wherein said ink layer is formed in positions corresponding to said keying units.
